(19) United States
(12) Patent Application Publication
(10) Pub. No.: US 2004/0052354 A1
(43) Pub. Date: Mar. 18, 2004

(54) Call routing in a multi-skills environment

(76) Inventor: Gary Crockett, Plano, TX (US)

Correspondence Address: Gregory W. Carr, CARR & STORM, L.L.P., 670 Founders Square, 900 Jackson Street, Dallas, TX, 75202, US

(21) Appl. No.: 09/780,312

(22) Filed: Feb. 9, 2001

(51) Int. Cl. H04M 3/00; H04M 5/00

(52) U.S. Cl. 379/266.03; 379/265.02

(57) ABSTRACT

A method and an apparatus for determining to which of one or more call centers a call should be routed. This is achieved by calculating an estimated answer delay from the queue length and the drain rate. The queue length is preferably based on the number of calls in the queue as reported by the call center and the calls sent to the call center since the last update. The drain rate is preferably based on evaluating the number of calls in the queue between updates. The method and apparatus allows for an efficient allocation of calls to one or more call centers comprising a multi-skills ACD.

### TECHNICAL FIELD

The invention relates generally to automatic call distribution systems and, more particularly, to providing a method and an apparatus for routing calls in a multi-skills environment.

### BACKGROUND

Telephone call centers are well-known and common in many industries. Typically, companies use call centers to provide customers with a single contact point, e.g., an “800” number, for such areas as technical support, sales support, customer service, billing, and the like. Often, a company organizes its call handling workforce into two or more call centers, such as a call center for an eastern sales area and another call center for a western sales area. Additionally, each call center may handle a variety of call types, each requiring different training and skills from the agents who handle the calls.

To route the calls to the two or more call centers, a company may configure one or more call routing systems that interact with carrier networks to select the destination for each incoming call. The call routing system, such as that described in U.S. Pat. No. 5,590,188 to Crockett entitled “Rules-Based Call Routing,” routes the call to an appropriate call center according to current and projected conditions of the call centers and by balancing competing business goals, such as lowering the cost of call handling, answering calls within a given amount of time, providing customized handling for certain calls, and the like. Each call center typically comprises an Automatic Call Distributor (ACD), or similar equipment capable of queuing and distributing calls, and agents. The agents are typically organized into teams of agents that are generally responsible for handling calls routed to the call center.

Generally, an ACD maintains queues of calls that are distributed to an agent or a team of agents. A given queue or set of queues will be served primarily by a single team, with certain exceptions providing relief when a team becomes overloaded, commonly referred to as a queue/team model. The ACD generally provides data to the call routing system in real-time, or near real-time, regarding the number of calls in each queue, the number of agents in each team, and the average handling time for calls in each queue. Given this data the call routing system is able to calculate the expected answer delay at each call center, and take this information into account when selecting the destination call center for a particular call.

In a queue/team environment, the answer delay is typically calculated as follows:

(Answer delay)=(calls in queue)*(average handle time)/(#agents serving queue)

Other secondary adjustments that are generally made, such as adjusting the queue length for calls routed but not yet received by the ACD and for the effect of expected call abandonments, are well known to a person of ordinary skill in the art and will not be discussed in further detail, except as required to describe the present invention.

Each of the above values, including the answer delay, are generally provided to the call routing system by each ACD. As discussed above, this information is used by the call routing system in determining to which call center an incoming call should be routed.

In recent years, however, some ACDs allow a skills-based call distribution model instead of the queue/team model discussed above. In a skills-based call distribution model, incoming calls are classified as one of one or more call types. The call types generally reflect the skills required of the agent assigned to handle the call. The ACD maintains a call-type queue of all calls of each call type and a list of agents possessing the necessary skills for each call type queue.

For instance, skills may comprise the ability to speak a particular language, to handle billing inquiries, or to advise about a particular product. Associated with each call-type queue is a set of rules that dictate which set of skills is eligible to handle the call under various conditions, such as a call distribution rule, “Calls on this queue always require the Spanish-speaking skill. Ordinarily the billing-inquiry skill is also required, but if a call has been waiting more than 60 seconds, agents with the customer-service skill are also eligible.”

While skills-based call distribution has many advantages, such as efficient use of the agent's skills and improving agent job satisfaction, skills-based call distribution creates problems for call routing systems. While calls are generally organized into recognizable queues, agents are no longer organized into teams. Instead, the agents are generally organized into an agent pool to which multiple call queues contend for services.

Therefore, it is difficult for the call routing system to calculate the expected answer delay for a given call-type queue because conditions on each call-type queue typically affect the behavior of the other queues, i.e., the number of available agents handling a given call-type queue can vary from moment to moment. Therefore, the call routing system cannot adequately estimate the answer delay at each call center, preventing the call routing system from performing load balancing among the call centers effectively.

Several approaches for call routing to skills-based ACDs have been attempted, each with disadvantages. One approach provides the call routing system with detailed knowledge of the skills-based distribution methods of the ACD and simulates in real-time the current call-type queue conditions against the ACD's distribution algorithms. This approach is difficult to administer and creates problems when ACDs develop new call-distribution capabilities.

Another approach is to “dumb down” the ACD. In this approach, the call routing system requires skills to be assigned in a manner that effectively leaves a primary team associated with each call-type queue. Unfortunately, this eliminates most of the benefits of skills-based call distribution by possibly restricting the types of calls an agent may handle.

Yet another approach allows the call routing system to control the call distribution function, essentially directing calls to individual agents instead of to ACD queues. This approach, however, prevents companies from taking advantage of innovations in call distribution by the ACD vendors, since the ACD is relegated to a role as a simple switch. This approach also typically adds expense, complexity, and risk because of the high volume of real-time information that must be provided to the call routing system from the call centers.

Therefore, what is needed is a method and a system for selecting a call center to which to route a call in a multi-skills environment.

### SUMMARY

The present invention provides a method and an apparatus through which calls may be effectively routed to one or more call centers, each call center comprising a multi-skills ACD. The method and apparatus comprises using information regarding the number of calls each call center handles to calculate the drain rate of a call type within each of the call centers. From the drain rate, an estimated answer delay before an agent answers a call is determined for each call center. In one aspect of the invention the call is routed to the call center with the lowest answer delay. In another aspect of the invention the delay at each call center is combined with other factors, such as the time of the call and the location from which the call was received, to select a call center. The present invention's method of estimating answer delay is equally applicable whether used as the sole decision criterion or combined with other criteria.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 schematically depicts the typical network environment that embodies the present invention;

FIG. 2 is a flow chart illustrating one embodiment in which the call center with the lowest delay time is determined;

FIG. 2A is a flow chart illustrating another embodiment in which the call center with the best merit value is determined;

FIG. 3 is a flow chart illustrating one embodiment in which the drain rate of a call-type is determined for a call center; and

FIG. 4 is a flow chart illustrating one embodiment in which the queue length of a call-type queue is determined for a call center.

### DETAILED DESCRIPTION

In the following discussion, numerous specific details are set forth to provide a thorough understanding of the present invention. However, it will be obvious to those skilled in the art that the present invention may be practiced without such specific details. In other instances, well-known elements have been illustrated in schematic or block diagram form in order not to obscure the present invention in unnecessary detail. Additionally, for the most part, details concerning telecommunications systems and the like have been omitted inasmuch as such details are not considered necessary to obtain a complete understanding of the present invention, and are considered to be within the skills of persons of ordinary skill in the relevant art.

It is further noted that, unless indicated otherwise, all functions described herein are performed by a processor such as a computer or electronic data processor in accordance with code such as computer program code, software, or integrated circuits that are coded to perform such functions.

The principles and advantages of the present invention are best understood by referring to the illustrated embodiment depicted in FIGS. 1-4. Additionally, pseudo-code comprising some of the elements of the following discussion is listed in Appendix A, which is attached herewith and hereby incorporated by reference. The pseudo-code is written in a form that would be readily interpreted and understood by one having ordinary skill in the art and, therefore, will not be discussed in further detail herein, except insofar as necessary to describe the present invention.

Referring to FIG. 1 of the drawings, the reference numeral 100 generally designates a call servicing system embodying features of the prior art. The call servicing system 100 comprises a call routing system 110 generally coupled between a telecommunications network 112, such as the Public Switched Telephone Network (PSTN), and one or more respective call centers 120 via an automatic call distributor (ACD) 122 operable within each respective call center. The telecommunications network 112 generally provides connectivity between one or more callers 114 and the call centers 120 via the ACDs 122.

The ACD 122 maintains one or more call type queues 124, as indicated schematically by the lines connecting each ACD 122 to its respective call type queue 124. A call center 120 also comprises one or more agents 126. Moreover, in a skills-based distribution system, each agent 126 is generally qualified to work on a subset of one or more of the call types 124, as indicated schematically by the lines connecting the agents 126 and the call type queues 124.

In operation according to the prior art, the call routing system 110 receives a query from the telecommunications network 112 requesting a destination for a call from caller 114. As described in further detail below, the call routing system 110 utilizes internal algorithms and call center information to determine to which call center 120 the call is best routed. Generally, the call center information, commonly referred to as an ACD update, is periodically received from the call centers 120 and generally comprises the number of calls in each call-type queue 124 and the average handling time for each call-type queue 124. For reasons discussed above, the prior art method of using such algorithms and call center information are problematic.

In accordance with the present invention, the call is preferably routed to the call center 120 with the lowest answer delay time. The delay time is the average time that a caller 114 will be placed on hold before an agent 126 assists the caller, and is preferably determined in accordance with the following equation:

Delay=Call-Type Queue Length/Drain Rate

The call-type queue length is the number of calls currently in the call-type queue 124. The drain rate is the number of calls per second that are consumed by being answered by the agents 126. For example, if the average call takes 180 seconds of talk time and after-call work time, and 90 agents are serving the queue, the drain rate for the queue would be 90 (agents) divided by 180 seconds per call, or 0.5 calls per second.

Notably, the prior art use of the ACD update generally provides neither the drain rate nor information, such as the number of agents handling a call-type queue 124, required to determine the drain rate. Unlike the prior art, in the present invention, the call routing system 110 is preferably configured to determine the drain rate based on information provided by the ACDs 122, such as the call-type queue lengths and the average handling time for each call type, and information known to the call routing system 110, such as the number of calls of each call type routed to each call center 120. It may be appreciated that an advantage of the present invention, then, is that the drain rate measurement requires neither detailed knowledge of the call distribution algorithms of the ACDs 122, nor detailed knowledge of skills of the individual agents 126, thereby allowing the call routing system 110 to be de-coupled from the ACD functionality and adapted to various ACD vendors.

FIG. 2 is a flow chart depicting steps that may be performed by the call routing system 110 in accordance with one embodiment of the present invention to utilize the drain rate to determine which call center 120 a call should be routed to. Accordingly, in step 206 a call is received from a caller 114 via the telecommunications network 112 and, in step 208, the call routing system 110 initializes (i.e., sets) a best (i.e., lowest) answer delay that is higher than the answer delay of any call center. In step 210, a first call center 120 is selected as a first call center to be a “current” call center for which a drain rate is calculated. Steps 212-223 comprise a loop for calculating the delay time for each call center 120, and for determining the call center 120 with the lowest delay time. Specifically, for the current call center 120, in step 212, the drain rate is calculated (as discussed further below with respect to FIG. 3) and, in step 214, the queue length is calculated (as discussed further below with respect to FIG. 4). In step 216, the answer delay is calculated for the current call center as the quotient of the queue length (step 212) divided by the drain rate (step 214). In step 218, a determination is made whether the delay calculated in step 216 is lower than the best (i.e., lowest) delay set or calculated thus far. If it is determined that the delay calculated in step 216 is lower than the best delay set or calculated thus far, then, in step 220, the current call center for which the answer delay was calculated is set as a preferred call center, and execution proceeds to step 222. If, in step 218, it is determined that the delay calculated in step 216 is not lower than the best delay set or calculated thus far, then execution proceeds directly to step 222, thereby bypassing step 220.

In step 222, a determination is made whether the answer delay has been calculated for all call centers 120. If it is determined that the answer delay has not been calculated for all call centers 120, then execution proceeds to step 223. In step 224, a next call center for which an answer delay has not been calculated is selected to be the current call center for determining an answer delay, and then execution returns to step 212. If, in step 222, it is determined that the answer delay has been calculated for all call centers 120, then execution proceeds to step 226, wherein the call received in step 206 is sent to the preferred call center identified in the loop defined by the steps 212-223.

FIG. 2A, which is a variation of FIG. 2, is another embodiment of the present invention wherein the estimated answer delay is not the sole decision criterion in choosing the preferred call center. Steps 206, 210-216, and 220-26 are substantially equivalent to the like-numbered steps of FIG. 2 and, therefore, will not be discussed in further detail in reference to FIG. 2A.

In step 209, the call routing system 110 initializes a best “merit” value to a value that is lower than the merit value of any call center. In step 217, a merit value is determined by an algorithm, such as that disclosed in U.S. Pat. No. 5,590,188 to Crockett entitled “Rules-Based Call Routing”, which is incorporated by reference in its entirety, that considers the estimated answer delay together with other decision criteria, such as the time of day the call was received, the day of the week the call was received, calling number information, caller-entered digits, call classifications, status data, planning data, and/or the location from which the query was received. In step 219, a determination is made whether the merit value calculated in step 217 is greater than the best merit value calculated thus far. If it is determined that the merit value calculated in step 217 is greater than the best merit value calculated thus far, then execution proceeds to step 220. If, in step 219, it is determined that the merit value calculated in step 217 is not greater than the best merit value calculated thus far, then execution proceeds to step 222.

FIG. 3 illustrates a method for calculating the drain rate, discussed above with respect to step 212 (FIG. 2), in accordance with a preferred embodiment of the present invention. Accordingly, upon completion of step 210 (FIG. 2), execution proceeds to step 212, the details of which are depicted by steps 310-322 of FIG. 3. In step 310, a determination is made whether the drain rate has been calculated for the current call center or whether a previous drain rate calculation is no longer valid, such as when the drain rate has not been calculated for a predetermined amount of time, such as from about zero minutes to one or more hours and, typically, from about 15 minutes to about 45 minutes and, preferably, about 20 minutes. If, in step 310, it is determined that the drain rate has not been calculated for the current call center or the previous drain rate calculation is no longer valid, the drain rate for the current call center is preferably calculated as the quotient of the planned staff divided by the average handling time, as in step 312. Preferably, the planned staff is determined based on the number of full-time-equivalent agents needed to handle the forecasted call volume for the given call type. The planned staff should be less than or equal to the number of agents with the requisite skill set to handle a call of the call type and is configured for a specific time of day, such as Wednesday between 2:00 P.M. and 2:15 P.M. Ideally the planned staffing for each call type is provided by a workforce management system, such as that described in U.S. Pat. No. 6,044,355 to Crockett and Leamon entitled “Skills-Based Scheduling for Telephone Call Centers.” Such a system will update planned staffing based on changing conditions and can communicate with the call routing system to provide current plans. Alternatively, a configured default setting may be used, based on system operators' knowledge of typical staffing requirements in the past. Precision in the planned staff number is not critically important, because the present invention adjusts quickly to actual current conditions.

If, in step 310, it is determined that the drain rate has been calculated for the current call center or the previous drain rate calculation is valid, then execution proceeds to step 314, wherein a determination is made whether the drain rate has been recently calculated, either in terms of time or the number of calls, such as two seconds or five calls. If, in step 314, it is determined that the drain rate has been recently calculated, the drain rate for the current call center is preferably set to the previously calculated drain rate for the current call center.

If, in step 314, it is determined that the drain rate has not been recently calculated, then execution proceeds to step 318, wherein a determination is made as to whether the call-type queue for the current call center is empty. Preferably, the call-type queue for the current call center is considered empty if the number of calls in the call-type queue is zero as reported in the most recent ACD update, otherwise the call-type queue will be considered not empty. If, in step 318, it is determined that the call-type queue for the current call center is empty, the drain rate for the current call center is calculated as illustrated in steps 320 and 322. In step 320, a raw drain rate is calculated preferably as the quotient of the planned staff divided by the average handling time. Next, in step 322, a weight is applied to the raw drain rate of the current call center and the previous drain rate of the current call center. Specifically, the product of the previous drain rate and a weight is added to the product of the raw drain rate and one less the weight. The weight is a predetermined value to balance the previous drain rate with the newly calculated drain rate, thereby limiting radical changes in the drain rate and smoothing the drain rate for the current call center over time. A typical range for the weight would be from about 0.2 to about 0.8 and, preferably, about 0.6. Preferably, the weight is configurable by system operators, who may adjust it to obtain a desired balance between responsiveness and smoothing.

If, in step 318, it is determined that the call-type queue is not empty, the drain rate for the current call center is calculated as illustrated in steps 324, 326, and 322. In step 324, the number of calls leaving the call-type queue of the current call center is preferably calculated as the sum of call-type queue length at the time of the previous drain rate calculation and the number of calls sent to the current call center since the most recent ACD update, less the number of calls in the most recent ACD update.

After the number of calls leaving the call-type queue of the current call center is determined in step 324, execution proceeds to step 326, wherein a raw drain rate is determined. The raw drain rate is preferably calculated as the quotient of the number of calls leaving the call-type queue, calculated in step 324, divided by the time elapsed since the last drain rate calculation for the call-type queue of the current call center. Next, in step 322, a weight is applied to the raw drain rate of the current call center and the previous drain rate of the current call center. Specifically, the product of the previous drain rate and a weight is added to the product of the raw drain rate and one less the weight.

Upon completion of the processing illustrated in FIG. 3, execution continues with step 214 (FIG. 2).

FIG. 4 illustrates the preferred method of determining the queue length, discussed above with respect to step 214 (FIG. 2), in accordance with a preferred embodiment of the present invention. Accordingly, upon completion of step 212 (FIG. 2), the execution proceeds to step 214, the details of which are depicted by steps 410-418 of FIG. 4. In step 410, a determination is made whether the call-type queue of the current call center is empty. Preferably, the determination is made by examining the number of calls in the call-type queue for the current call center as reported in the most recent ACD update. If the number of calls in the call-type queue is zero, the call-type queue is treated as being empty, otherwise the call-type queue is considered not empty.

If, in step 410, it is determined that the call-type queue is not empty, then execution proceeds to step 412. In step 412, the queue length of the call-type queue of the current call center is preferably calculated as the sum of number of calls in the most recent ACD update and the number of calls the call routing system has sent to the ACD since the most recent ACD update, less the product of the drain rate, as calculated in FIG. 3, and the time elapsed since the last ACD update.

If, in step 410, it is determined that the call-type queue is empty, then the queue length is calculated as illustrated in steps 414, 416, and 418. In this scenario, a queue length is estimated in order to equally balance the workload in the situations in which there are sufficient number of available agents to service the incoming calls.

In step 414, an estimated capacity is calculated as the quotient of the product of the recent time and the number of agents, divided by the average handling time. The recent time is preferably a configuration parameter that represents the amount of time over which the capacity is to be calculated, such as from about zero minutes to one or more hours and, typically, from about five minutes to about 30 minutes and, preferably, about five minutes. The average handling time is the average handling time for calls in a call-type queue for the current call center as reported in the most recent ACD update.

The number of agents represents the number of agents currently handling calls of the call type. When a drain rate has been calculated for the call type, the number of agents may be inferred by multiplying the drain rate by the average call handling time. Otherwise, the planned staffing, determined as described previously, can be used. After, in step 414, the capacity is determined, an initial queue length is determined in step 416. The initial queue length is preferably calculated as the quotient of the product of the number of agents, as determined above, and the number of calls recently (using the same value for “recent” that was used in calculating capacity) routed to the ACD, divided by the capacity as calculated above, less the number of agents. In step 418, the queue length is calculated as the sum of the initial queue length and the number of calls of a call type sent to the current call center since the most recent ACD update, less the product of the drain rate and the recent time used in calculating the capacity. Upon completion of the processing illustrated in FIG. 4, execution continues with step 216 (FIG. 2).

It is understood that the present invention can take many forms and embodiments. Accordingly, several variations may be made in the foregoing without departing from the spirit or the scope of the invention. For example, different ACD statistics than the ones described could be used to calculate values such as average handle time and queue length. For another example, the functions of call routing to call centers and some of the ACD functions of distributing calls to individual agents and providing statistics for call routing could be combined in a single system. For another example, answer delay may or may not be combined with other decision criteria in selecting a preferred call center, and the nature and method of using such other decision criteria may vary.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments. Accordingly, it is appropriate that the appended claims be construed broadly and in a manner consistent with the scope of the invention.

[image]

[image]

[image]

[image]

[image]

[image]

[image]

1. A method of selecting which of one or more call centers to route a call of a particular call type, the method comprising the steps of:
determining a queue length of a queue for the particular call type for each of the one or more call centers;
determining a drain rate for each of the one or more call centers for the particular call type;
determining for each of the one or more call centers a delay substantially equal to the quotient of the queue length divided by the drain rate; and
selecting the call center to which the call will be routed based at least in part on the lowest delay.

2. The method of claim 1, wherein the step of selecting the call center is further performed with reference to one or more of the time of day, the day of the week, calling number information, caller-entered digits, call classifications, status data, planning data, and the delay.

3. The method of claim 1, wherein the step of determining the drain rate further comprises calculating the drain rate as substantially equal to the quotient of a number of planned staffing divided by an average handling time for the calls of a particular call type.

4. The method of claim 1, wherein the step of determining the drain rate further comprises the steps of:
determining whether the drain rate has not been previously calculated or whether a previously calculated drain rate is outdated; and
upon a determination that the drain rate has not been previously calculated or that the previously calculated drain rate is outdated, calculating the drain rate as substantially equal to the quotient of the number of planned staffing divided by an average handling time for the calls of a particular call type .

5. The method of claim 1, wherein the step of determining the drain rate further comprises calculating the drain rate as substantially equal to a previously calculated drain rate.

6. The method of claim 1, wherein the step of determining the drain rate further comprises the steps of:
determining whether the drain rate has been recently calculated; and
upon a determination that the drain rate has been recently calculated, calculating the drain rate as substantially equal to a previously calculated drain rate .

7. The method of claim 1, wherein the step of determining the drain rate further comprises calculating the drain rate as substantially equal to a raw drain rate weighted with a previous drain rate, the raw drain rate being the number of planned staff divided by the average handling time of calls of the particular call type.

8. The method of claim 1, wherein the step of determining the drain rate further comprises the steps of:
determining whether the queue for the particular call type is empty; and
upon a determination that the queue for the particular call type is empty, calculating the drain rate as substantially equal to a raw drain rate weighted with a previous drain rate, the raw drain rate being the number of planned staff divided by the average handling time of calls of a particular call type.

9. The method of claim 1, wherein the step of determining the drain rate further comprises calculating the drain rate as substantially equal to a raw drain rate weighted with a previous drain rate, the raw drain rate being the quotient of a number of calls leaving the queue of the particular call type divided by the time elapsed since the last drain rate calculation, the number of calls leaving the queue of the particular call type being the queue length of the queue of the particular call type as of a previous drain rate calculation less the number of calls in a previous ACD update plus a number of calls sent to the call center since the previous ACD update.

10. The method of claim 1, wherein the step of determining the drain rate further comprises the steps of:
determining whether the queue of the particular call type is not empty; and
upon a determination that the queue of the particular call type is not empty, calculating the drain rate as substantially equal to a raw drain rate weighted with a previous drain rate, the raw drain rate being the quotient of a number of calls leaving the queue of the particular call type divided by the time elapsed since the last drain rate calculation, the number of calls leaving the queue of the particular call type being the queue length of the queue of the particular call type as of a previous drain rate calculation less the number of calls in a previous ACD update plus a number of calls sent to the call center since the previous ACD update.

11. The method of claim 1, wherein the step of determining the queue length further comprises the steps of:
receiving an update from a call center, the update comprising the number of calls in the queue of the particular call type;
determining a sum of:
a number of calls sent to the queue of the particular call type since the update from the call center; and
the number of calls in the queue of the particular call type received from the update; and
determining the queue length as substantially equal to the difference between the sum and the product of the drain rate and an elapsed time, the drain rate being the rate at which calls are removed from the queue of the particular call type and the elapsed time being the time elapsed since the update.

12. A computer program product for determining to which of one or more call centers to route a call of a particular call type, the computer program product having a medium with a computer program embodied thereon, the computer program comprising:
computer program code for determining a queue length for each of the one or more call centers for the particular call type;
computer program code for determining a drain rate for each of the one or more call centers for the particular call type;
computer program code for determining for each of the one or more call centers a delay substantially equal to the quotient of the queue length divided by the drain rate; and
computer program code selecting the call center to which the call will be routed based at least in part on the lowest delay.

13. The computer program of claim 12, wherein the computer program code for selecting the call center is further performed with reference to one or more of the time of day, the day of the week, calling number information, caller-entered digits, call classifications, status data, planning data, and the delay.

14. A programmed call routing system for selecting which of one or more call centers to route a call of a particular call type, the programmed call routing system comprising:
circuitry for determining a queue length of a queue for the particular call type for each of the one or more call centers;
circuitry for determining a drain rate for each of the one or more call centers for the particular call type;
circuitry for determining for each of the one or more call centers a delay substantially equal to the quotient of the queue length divided by the drain rate; and
circuitry for selecting the call center to route the call of the particular call type based at least in part on the lowest delay.

15. The programmed call routing system of claim 14, wherein the circuitry for selecting the call center is further performed in reference to one or more of the time of day, the day of the week, calling number information, caller-entered digits, call classifications, status data, planning data, and the delay.

16. The programmed call routing system of claim 14, wherein the circuitry for determining the drain rate further comprises circuitry for calculating the drain rate as substantially equal to the quotient of a number of planned staffing divided by an average handling time for the calls of a particular call type.

17. The programmed call routing system of claim 14, wherein the circuitry for determining the drain rate further comprises:
circuitry for determining whether the drain rate has not been previously calculated or whether a previously calculated drain rate is outdated; and
circuitry for calculating the drain rate upon a determination that the drain rate has not been previously calculated or that the previously calculated drain rate is outdated, the drain rate being substantially equal to the quotient of a number of planned staffing divided by an average handling time for the calls of a particular call type.

18. The programmed call routing system of claim 14, wherein the circuitry for determining the drain rate further comprises circuitry for calculating the drain rate as substantially equal to a previously calculated drain rate.

19. The programmed call routing system of claim 14, wherein the circuitry for determining the drain rate further comprises:
circuitry for determining whether the drain rate has been recently calculated; and
circuitry for calculating the drain rate upon a determination that the drain rate has been recently calculated, the drain rate being substantially equal to a previously calculated drain rate.

20. The programmed call routing system of claim 14, wherein the circuitry for determining the drain rate further comprises circuitry for calculating the drain rate as substantially equal to a raw drain rate weighted with a previous drain rate, the raw drain rate being the number of planned staff divided by the average handling time of calls of the particular call type.

21. The programmed call routing system of claim 14, wherein the circuitry for determining the drain rate further comprises:
circuitry for determining whether the queue for the particular call type is empty; and
circuitry for calculating the drain rate upon a determination that the queue for the particular call type is empty, the drain rate being substantially equal to a raw drain rate weighted with a previous drain rate, the raw drain rate being the number of planned staff divided by the average handling time of calls of a particular call type.

22. The programmed call routing system of claim 14, wherein the circuitry for determining the drain rate further comprises circuitry for calculating the drain rate as substantially equal to a raw drain rate weighted with a previous drain rate, the raw drain rate being the quotient of a number of calls leaving the queue of the particular call type divided by the time elapsed since the last drain rate calculation, the number of calls leaving the queue of the particular call type being the queue length of the queue of the particular call type as of a previous drain rate calculation less the number of calls in a previous ACD update plus a number of calls sent to the call center since the previous ACD update.

23. The programmed call routing system of claim 14, wherein the circuitry for determining the drain rate further comprises:
circuitry for determining whether the queue of the particular call type is not empty; and
circuitry for calculating the drain rate upon a determination that the queue of the particular call type is not empty, the drain rate being substantially equal to a raw drain rate weighted with a previous drain rate, the raw drain rate being the quotient of a number of calls leaving the queue of the particular call type divided by the time elapsed since the last drain rate calculation, the number of calls leaving the queue of the particular call type being the queue length of the queue of the particular call type as of a previous drain rate calculation less the number of calls in a previous ACD update plus a number of calls sent to the call center since the previous ACD update.

24. The programmed call routing system claim 14, wherein the circuitry for determining the queue length further comprises:
circuitry for receiving an update from a call center, the update comprising the number of calls in the queue of the particular call type;
circuitry for determining a sum of:
a number of calls sent to the queue of the particular call type since the update from the call center; and
the number of calls in the queue of the particular call type received from the update; and
circuitry for determining the queue length as substantially equal to the difference between the sum and the product of the drain rate and an elapsed time, the drain rate being the rate at which calls are removed from the queue of the particular call type and the elapsed time being the time elapsed since the update.
